(19) United States
(12) Patent Application Publication
(10) Pub. No.: US 2018/0026991 A1
(43) Pub. Date: Jan. 25, 2018

(54) SOCIAL NETWORK PRIVACY AUDITOR

(71) Applicant: THOMSON Licensing, Issy-les-Moulineaux (FR)

(72) Inventors: Subrahmanya Sandilya Bhamidipati, Sunnyvale, CA (US); NADIA FAWAZ, Santa Clara, CA (US)

(21) Appl. No.: 15/721,179

(22) Filed: Sep. 29, 2017

Related U.S. Application Data
(63) Continuation of application No. 14/647,878, filed on May 28, 2015, now abandoned.

(51) Int. Cl. H04L 29/06; G06F 21/53; G06F 21/62; G06Q 50/00; G06Q 10/00

(52) U.S. Cl. CPC H04L 63/105; G06F 21/6263; H04L 63/104; G06Q 50/01; G06F 21/53; H04L 63/20; G06F 2212/1032; G06F 2221/2101; G06Q 10/00

(57) ABSTRACT

A privacy auditor determines discrepancies between user privacy settings in a social network and installed applications. The privacy auditor can employ a privacy determinator that tests an installed application on various privacy levels to determine actual privacy settings of the installed application. The privacy auditor then uses a privacy comparator to derive differences between the actual privacy settings of the installed application and the user privacy settings from the social network.

### CROSS-REFERENCE TO RELATED APPLICATION

This is a continuation of co-pending U.S. patent application Ser. No. 14/647,878 filed May 28, 2015 which is a 371 of International Application No. PCT/US2012/068106 filed Jun. 12, 2014 incorporated by reference herein in its entirety.

### BACKGROUND

Users who join a social network are often asked to select various privacy options. These options can include different privacy levels for information with the levels dependent on the user's social association with another user of the social network. For example, certain photographs can be made available to only family members of the user. Other photographs can be made available to friends or possibly acquaintances of their friends and the like. These privacy choices allow the user to carefully control the exposure of their information on the social network.

However, third party applications tied to the social network may or may not adhere to the privacy settings selected by the user. The user typically blindly assumes that the third party application will follow their settings from the social network. This is often not the case, and the user unknowingly allows their private information to be exposed. For example, in “A Haskell and Information Flow Control Approach to Safe Execution of Untrusted Web Applications,” Stefan Deian, Talk at Stanford University, Apr. 11, 2011 (http://forum.stanford.edu/events/2011slides/security/2011 security Stefan.pdf, http://forum.stanford.edu/events/2011deianstefaninfo.php), the author noticed that a privacy mismatch occurs when social media applications, such as Facebook applications, are installed, and the author proposed a solution to force a Facebook application to respect privacy settings. However, the author does not provide a means to detect the mismatch in a systematic way for any social network.

### SUMMARY

An auditing means is used to detect whether a privacy mismatch occurs between a social network's privacy settings and a third party application to permit a social network to take action to make the application comply with the privacy rules if so desired. In one instance, a system is constructed for a social network which shows the privacy mismatch between what the user believes is private according to the privacy settings they selected and what can actually be collected about them, for example, by an application installed by a friend and/or a friend of friend and/or anyone.

The above presents a simplified summary of the subject matter in order to provide a basic understanding of some aspects of subject matter embodiments. This summary is not an extensive overview of the subject matter. It is not intended to identify key and/or critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is an example of a mismatch between a user's privacy settings and data accessible by applications installed by associations of the user which possess various degrees of association in a social network.

FIG. 2 is a flow diagram of an example method of determining privacy mismatches.

FIG. 3 is an example of a system that employs a privacy auditor to verify social network privacy settings of a user.

FIG. 4 is an example of a system that uses a privacy auditor to test an installed application for violations of user social network privacy settings.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

Currently, there is a lack of information on data that a social network application can access when the user clicks an application install button. Indeed, the install application button does more than just install an application, it also grants permissions to access additional user data, beyond the basic information as mentioned in the installation message shown to the user. Thus, the user has incomplete knowledge of which pieces of their information are being accessed by the application. The install button may also grant the application access to information about the people they are connected to in a network setting.

To prevent this type of inadvertent loss of privacy, a social network privacy auditor is constructed which shows the mismatch between a social network user's privacy settings and actual data which can be collected about a social network user with or without their knowledge or consent. If a user marks parts of their data and/or profile with different levels of privacy, the privacy auditor can show which data has an actual level of privacy that is lower (less secure) than the level indicated in a user's privacy settings. Some social networks make application developers sign a document saying that they will respect a user's privacy and not access data they are not supposed to access, and to not share such data with another party. However, these social networks do not have any system to enforce these rules by checking if an application complies with the social network platform policies about privacy and warning them if they do not (for example, see generally, Facebook Platform Policies http://developers.facebook.com/policy/). The privacy auditor is a means to audit compliance of an application with the user's privacy settings and the platform terms and policies, and can then take action to enforce compliance if so desired.

The privacy auditor can show mismatches between privacy settings, for example, such as separate privacy settings for a user's friends, friends of friends and/or anyone. These types of settings are used as an example as the privacy auditor can be constructed based on any type of relationship between users of a social network (e.g., immediate family, cousins, aunts, uncles, classmates of various institutions, etc.) and is not intended to be limiting in any manner. In one instance, a basic algorithm uses the social network privacy settings of a primary user. These can be, initially, default values provided by the social network and/or values provided directly and/or indirectly by the user of the social network. The associations can be construed as degrees of social association between a primary user and other users and the like. The higher the degree the less value a user places on that association (the user does not trust the association as much as a lower numbered degree association). However, one skilled in the art can appreciate that the degree number can be reversed as well, and, thus, the higher the degree, the more value a user places on the association. For example purposes, the former degree definition will be used.

In this example, another user of the social network is installing an application associated with the social network. If this user is a direct friend of a primary user, a 1^{st} degree of association is established by the privacy auditor. When the application is installed by a friend of a friend, a 2^{nd} degree of association is established. When the application is installed by, for example, anyone, a 3^{rd} degree (or more) of association is established. The privacy auditor then tests and creates comparative data to illustrate mismatches between the social network privacy settings of the primary user and other users with various degrees of association.

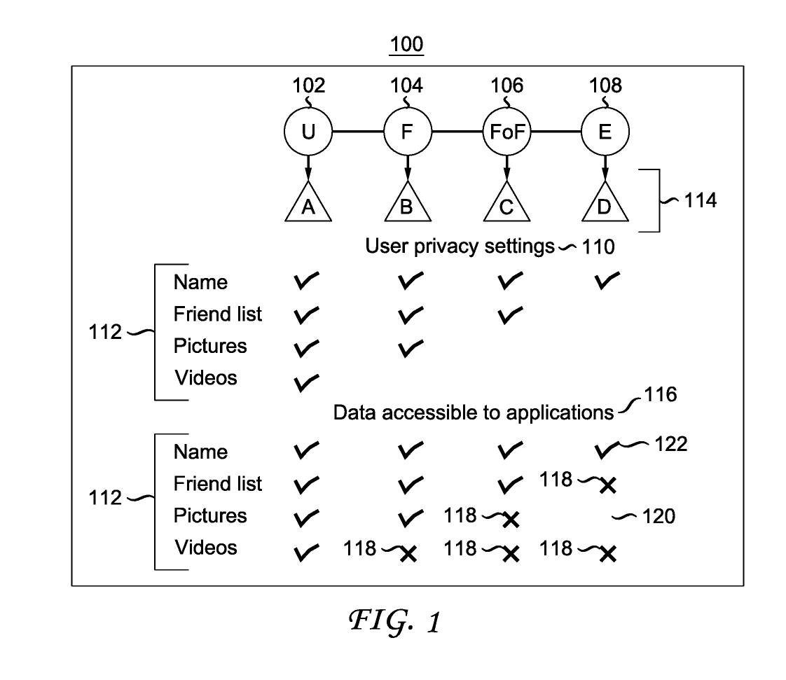

FIG. 1 shows an example of mismatch data 100 provided by the privacy auditor for a primary user 102. The primary user 102 has a direct friend 104 and also a friend of a friend 106 that use a social network. In this example, the primary user 102 has also designated a degree of association that includes everyone 108. The primary user 102 has selected user privacy settings 110 for various types of data 112. In this instance, the types of data 112 include name, friend list, pictures and videos. One can appreciate that a vast amount of different types of data can still be employed with the privacy auditor, and it is not limited by the type and/or quantity of types of data. In this scenario, each of the users with different degrees of association can install an application 114. When this occurs, the primary user's privacy settings 110 are compared to data accessible to the applications 116.

If the applications 114, can retrieve data that the user has restricted based on a degree of association, the primary user 102 and/or the social network and/or the application is warned/notified 118 through a user interface (UI) and/or via other communication means (e.g., emails, text message, cell call, etc.). The warning/notification in FIG. 1 is shown as an “X” wherever the restricted data has been compromised (data which can actually be accessed by an application although privacy settings do not authorize the access). If the application has adhered to the social network's privacy policies and does not have access to restricted data, an “X” is not shown 120. If the application has access but the access is authorized according to the privacy policies, a check mark 122 is shown. It can be appreciated that the warning 118 can also be audible and/or include other sensory type indications rather than a display as shown in FIG. 1. A warning email and/or text message and the like can also be sent to the primary user 102 to notify them of a discrepancy in the privacy policies followed by the applications 114. An automated response can also be implemented by the social network (e.g., disallowing the application completely, limiting its access, penalizing the application's owner monetarily, etc.).

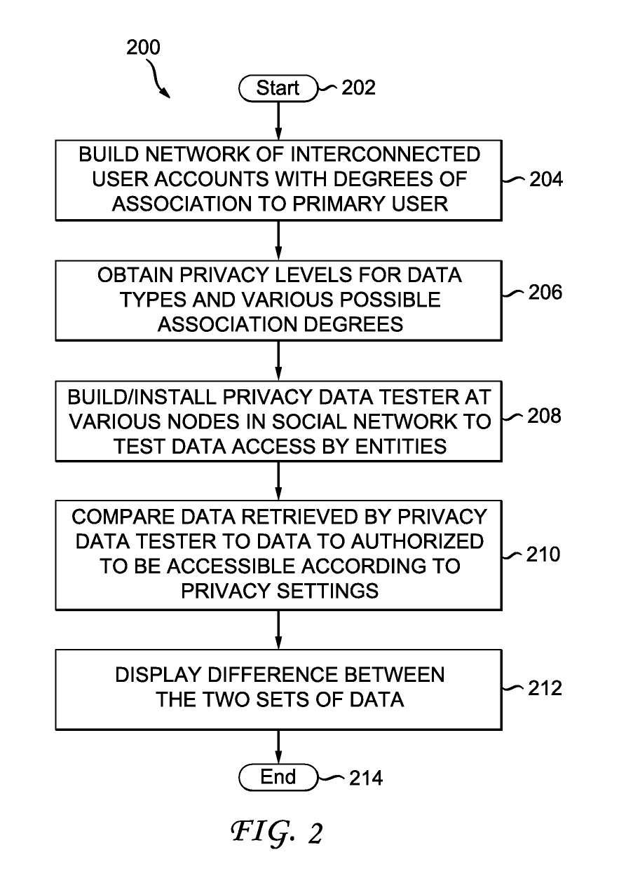

In FIG. 2, an example method 200 of determining privacy mismatches is shown. The method 200 starts 202 by building a network of interconnected user accounts of a social network with degrees of association to a primary user 204. The degrees of association can include, for example, a user, a friend, a friend of a friend and additional further associations/connections to the primary user. Privacy levels can then be obtained for data types and various possible association degrees 206. This information is typically provided by a primary user but can also include information obtained from default values provided by a social network, etc. Privacy data testers are then built and/or installed at various nodes in the social network to test data access by entities 208. The number of privacy data testers is typically determined by the number of degrees of association to a primary user. Each privacy data tester can be built to test data access based on a particular degree of association. However, a single tester can also be constructed to test multiple types of data access by multiple degrees of association. When these testers are operated, automatically and/or manually, they determine the types of data accessible to entities independent of the social network's privacy policies.

The data retrieved by the privacy data testers is then compared to data authorized to be accessible according to privacy settings of the social network 210. Any discrepancies are noted. The differences between the two sets of data are then displayed 212, ending the flow. One skilled in the art can appreciate that the data does not have to be displayed but can also be sent to the social network, primary user and/or offending entities by other means (e.g., email notification, direct notification over a network, etc.). Once communicated, the social network can take action to further limit privacy violations of the offending entity if so desired. This can include disrupting the offending entity's operations, warning the user and/or other types of actions such as monetary fines to the owner of an offending application and the like.

The privacy auditor has the advantage of having the ability to see which part of the user data is actually private and which pieces of information are leaking through applications. If a rogue application tries to access user information by violating the terms and conditions of privacy, the social network can alert the user and take action against the application.

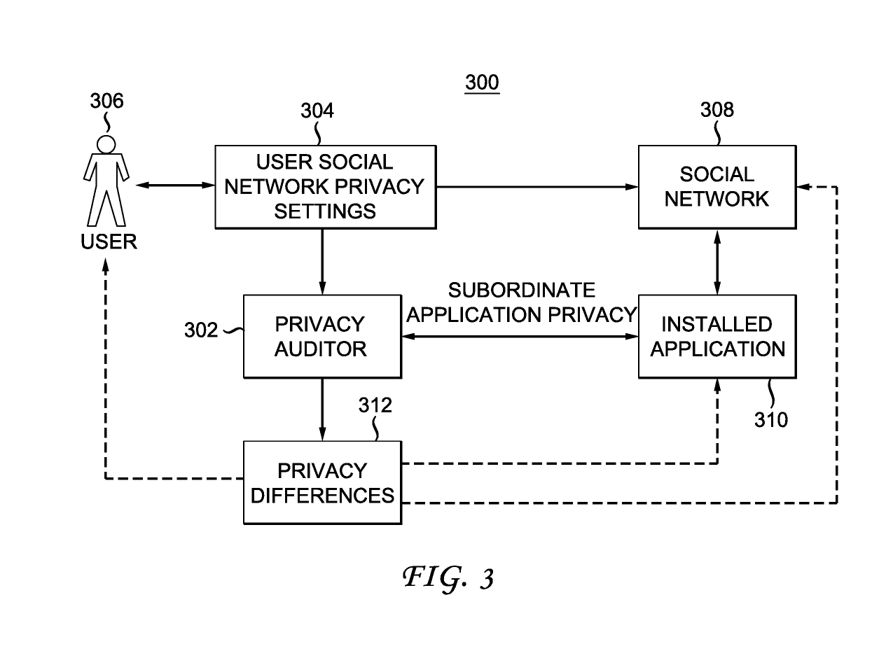

FIG. 3 illustrates a system 300 that employs a privacy auditor 302 to verify social network privacy settings 304 of a user 306. The user provides the user social network privacy settings 304 to a social network application 308 and the privacy auditor 302. This can occur directly and/or indirectly to the privacy auditor 302 (the user 306 can send the data directly and/or submit it to the social network 308 which in turn sends it to the privacy auditor, etc.). When an application 310 that is associated with the social network 308 is installed, the privacy auditor 302 tests the installed application 310 to determine privacy differences 312 between the actual data retrieved compared to the user social network privacy settings 304. The privacy auditor can emulate various interfaces to directly and/or indirectly test what data can be retrieved by the installed application 310. Once the privacy differences 312 are determined, the differences 312 can be sent to the user 306, the social network 308 for action and/or to the installed application 310 to make it aware of the violation of privacy. The social network 308, once aware of the violations, can take action directly and/or indirectly against the installed application 310. This could include halting operations of the installed application 310, limiting its data access and/or levying a monetary charge against the owner of the application and the like.

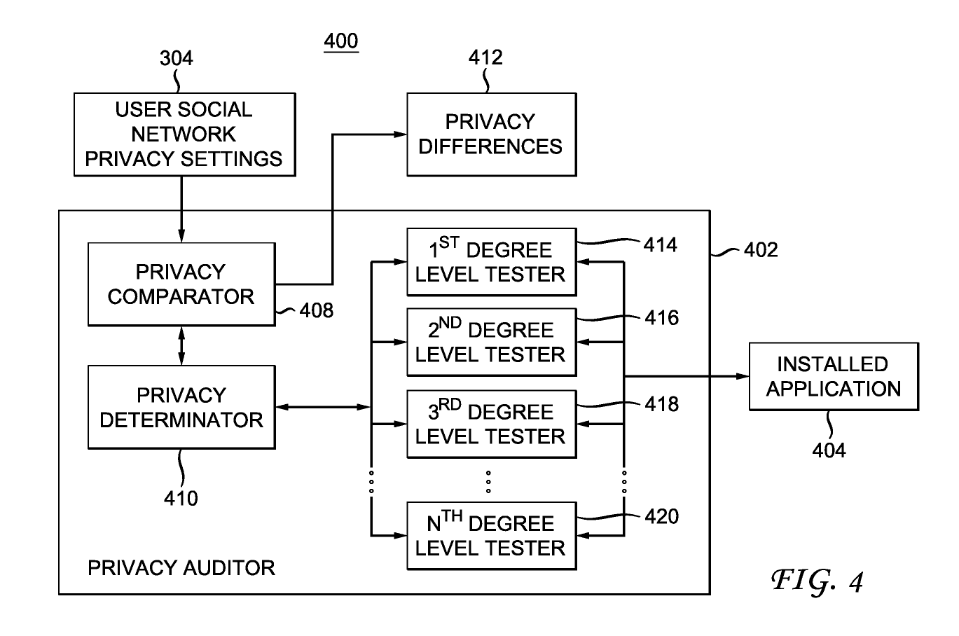

In one instance shown in FIG. 4, a system 400 uses a privacy auditor 402 to test an installed application 404 for violations of user social network privacy settings 406. The privacy auditor 402 employs a privacy comparator 408 that compares the user social network privacy settings 406 to actual accessed data determined by a privacy determinator 410 to derive privacy differences 412. As noted above, the user social network privacy settings 406 can be user provided, social network provided, default settings and/or a combination of any part or all of the aforementioned. In this example, the privacy determinator 410 tests the installed application 404 by using data access level testers 414-420 to emulate various degrees of association to a primary user. A 1^{st} degree level tester 414 can represent the primary user themselves. A 2^{nd} degree level test 416 can represent a direct friend of the primary user. A 3^{rd} degree level tester 418 can represent a friend of a friend of the primary user. The N^{th} degree level tester 420 can represent the least associated degree of access, where N can represent any positive integer. The purpose of the level testers 414-420 is to emulate data requests that would come from the various types of users that the primary user has listed. The level testers 414-420 then report back to the privacy determinator 410 as to whether their data requests were successful or not. The privacy determinator 410 then passes the results to the privacy comparator 408. The privacy comparator 408 then compares the actual data accessed against the user social network privacy settings. 406 to determine the privacy differences 412. The privacy comparator 410 can then communicate a warning and/or notification if a discrepancy is detected. The privacy comparator 410 can also generate a user interface that shows the compared information (regardless of whether a discrepancy was or was not found).

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A social network privacy auditor in a hardware node, comprising:
a privacy determinator configured to:
interface with an application associated with a social network to test what user data can be retrieved by the application; and
determine based on the user data that can be retrieved by the application, data access levels of the application; and
a privacy comparator configured to:
compare social network privacy settings of a primary user of the social network with the determined data access levels;
detect a privacy difference in case of a mismatch between the social network privacy settings of the primary user and the data access levels of the application; and
upon detection of the privacy difference, notify one or more of the social network, the primary user and the application;
wherein the data access levels are based on a degree of association of the primary user of the social network and a secondary user who initiates an installation of the application associated with the social network.

2. The social network privacy auditor of claim 1, wherein the privacy determinator is configured to emulate the secondary user with different degrees of association with the primary user to determine the data access levels of the application associated with the social network.

3. The social network privacy auditor of claim 1, wherein the social network privacy settings are based on at least one of user settings, social network settings, social network default settings and combinations of said user settings and said social network settings.

4. The social network privacy auditor of claim 1, wherein the privacy comparator is further configured to create a user interface that shows compared information between the social network privacy settings and the determined data access levels.

5. A method for evaluating privacy settings, comprising:
testing what user data can be retrieved by an application associated with a social network to test by interfacing with the application;
determining, based on the user data that can be retrieved by the application, data access levels of the application; and
comparing social network privacy settings of a primary user of the social network with the determined data access levels;
detecting a privacy difference in case of a mismatch between the social network privacy settings of the primary user and the data access levels of the application; and
upon detection of the privacy difference, notifying one or more of the social network, the primary user and the application,
wherein the data access levels are based on a degree of association of the primary user of the social network and a secondary user who initiates an installation of the application associated with the social network.

6. The method of claim 5 further comprising displaying results of the comparing of the social network privacy settings of a primary user of the social network with the determined data access levels.

7. The method of claim 5, wherein the degrees of association include at least one of a friend, a friend of a friend, a relative and a user unknown to the primary user.
